(19) United States
(12) Patent Application Publication
(10) Pub. No.: US 2015/0102189 A1
(43) Pub. Date: Apr. 16, 2015

(54) ADJUSTABLE FLASHLIGHT HOLDER

(71) Applicant: Thomas L. Klamm, Racine, WI (US)

(72) Inventor: Thomas L. Klamm, Racine, WI (US)

(21) Appl. No.: 14/471,073

(22) Filed: Aug. 28, 2014

Related U.S. Application Data
(60) Provisional application No. 61/891,154, filed on Oct. 15, 2013.

(51) Int. Cl. F21V 19/02; F16M 11/12; F16M 13/02

(52) U.S. Cl. CPC F21V 19/02; F16M 13/022; F16M 11/12
USPC 248/160; 248/176.3

(57) ABSTRACT

A holder for a flashlight includes a base from which a flexible shaft extends. The base has a permanent magnet for attaching the holder onto or adjacent to the workpiece. The shaft has a first end attached to the base and comprises an elongated, flexible metal core that preferably is surrounded by a resilient coating. The material of the shaft is such that when the shaft is bent into a given shape around flashlight, the core retains the given shape to hold onto the flashlight.

### CROSS-REFERENCE TO RELATED APPLICATIONS

This application claims benefit of U.S. Provisional Patent Application No. 61/891,154 filed on Oct. 15, 2013.

### STATEMENT REGARDING FEDERALLY SPONSORED RESEARCH OR DEVELOPMENT

Not Applicable

### BACKGROUND OF THE INVENTION

1. Field of the Invention

The present invention relates to devices for holding flashlights, and particularly to such devices that can hold flashlights in a number of user adjustable positions.

2. Description of the Related Art

Mechanics and other service technicians frequently illuminate a work area using a flashlight, especially in situations where electricity from a utility company is not available nearby. In situations where a worker desires to be able to use both hands, the flashlight is often held in the worker's mouth while performing a task. It is therefore desirable to provide a holder that can be removably attached to the work object and allow the flashlight to be positioned so as to illuminate the desired area.

### SUMMARY OF THE INVENTION

A holder for a flashlight includes a base from which a flexible shaft extends. The base has a permanent magnet for attaching the holder to the workpiece or an object adjacent to the workpiece. The shaft has a first end attached to the base and comprises an elongated, flexible metal core. The material of the shaft is such that when the shaft is bent into a given shape around flashlight, the core retains the given shape to hold onto the flashlight.

In one embodiment, the shaft further comprises a resilient coating surrounding the core.

In an embodiment of the holder, a handle couples the flexible shaft to the base and in another embodiment a strain relief couples the shaft to the base.

### BRIEF DESCRIPTION OF THE DRAWINGS

FIG. 1 is a perspective view of a first flashlight holder according to the present invention;

FIG. 2 is a bottom view of the flashlight holder without a protective covering;

FIG. 3 is a bottom view of the flashlight holder with a protective covering;

FIG. 4 is a perspective view of a first flashlight holder with a strain relief;

FIG. 5 is a perspective view of the first flashlight holder with a flashlight attached thereto;

FIG. 6 is a second flashlight holder according to the present invention; and

FIG. 7 is a perspective view of a second flashlight holder with a strain relief.

### DETAILED DESCRIPTION OF THE INVENTION

Reference herein to directional relationships and movement, such as top and bottom or left and right, refer to the relationship and movement of the components in the orientations illustrated in the drawings, which may not be the orientation of the components when the holder is in use. The term “directly connected” as used herein means that the associated components are connected together by a conduit without any intervening element, other than a conventional connector (such as a bolt, a machine screw, or a threaded shaft), or fastening method (such as welding, soldering, swaging, or crimping).

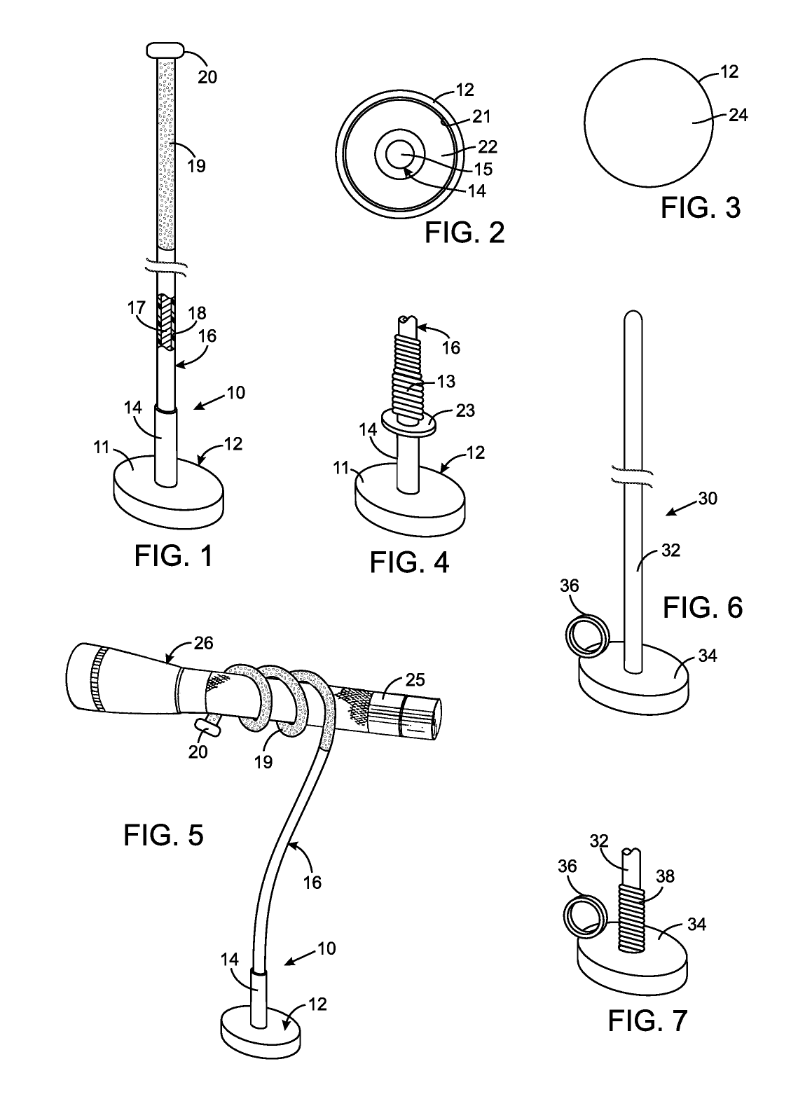

With initial reference to FIG. 1, a flashlight holder 10 comprises a base 12 with a first major surface 11 from which a handle 14 projects. For example, a bolt may extends through a central hole in the base 12 and is threaded into a proximate end of the handle 14, or that proximate end may have a short rod 15 projecting therefrom through the hole in the base and then peened against the bottom of the base as shown in FIG. 2. Alternatively, the base 12 and handle 14 can be integrated into a single piece. The handle 14 may be longer or shorter than is depicted in the drawings. Although the base is depicted as a circular disk, the disk may have other geometric shapes, such as an oval, a square, a hexagon, etc., and non-disk bases also may be used.

A flexible shaft 16 projects outward from the distal end of the handle 14, that is remote from the base 12. For example, the handle 14 can be a tube within which the shaft 16 is received, or the handle can be a solid rod having an aperture at the end remote into which the shaft 16 extends. The shaft 16 is secured in the handle 14 by swaging, for example, although other attachment methods can be employed. Alternatively, as shown in FIG. 4, a conventional strain relief 13, such as a spring for example, may fasten the flexible shaft 16 to the handle 14 to restrict the shaft from flexing sharply at that interface which over time could produce fatigue in the shaft. An optional plate 23 also is shown in FIG. 4 to aid in grabbing the handle 14 when removing the flashlight holder 10 from the workpiece or other object to which the holder is magnetically attached. The exemplary plate 23 has a disk shape with a central aperture through which the handle extends and at which those components are welded together. Plates having other shapes and relative sizes may be used as well as other techniques for fastening the plate 23 to the handle 14. A user can grasp the handle 14 between the base 12 and the plate 23. Either one or both of the strain relief 13 and the plate 23 optionally can be used on a given flashlight holder 10.

The shaft 16 preferably has a core 17 surrounded by an exterior resilient coating 18 that provides an outer surface which will not mar a flashlight being held by the device. The core 17 may be composed of a metal, such as lead, zinc, copper, aluminum, iron, steel, or alloys thereof, for example, and an exterior resilient coating 18 may be plastic or rubber. Optionally, a section 19 proximate to the tip of the shaft 16 may have a different coating formed by a polymer foam to provide a cushion for gripping the flashlight. Other types of shafts, such as one with a stranded core or an uncoated core may be used. Of primary consideration is that the shaft 16 possess characteristics of being shapeable by hand, retaining such formed shape, holding a flashlight without changing shape, and capable of being reshaped repeatedly without significant weakening over a reasonable amount of normal use. An optional knob 20 may be attached to the tip of the shaft 16 to aid a user in grasping the shaft to wind the shaft around the flashlight, as shown in FIG. 5.

As seen in FIG. 2, the bottom side of the disk-shaped base 12, opposite major surface 11, has a circular recess 21. An annular permanent magnet 22 is affixed in the recess 21 and extends around the end of the handle 14 that projects through the central aperture in the base. The bottom side of the base 12 may be left open as shown in FIG. 2; or as shown in FIG. 3, the bottom side may be covered by a sheet 24 of magnetically transparent material, such as paper or plastic.

FIG. 5 illustrates the holder 10 attached to a flashlight 26. The distal end of the shaft 16 from the base 12 is wrapped in a spiral around the barrel 25 of the flashlight 26, thereby securing the flashlight to the holder 10. The shaft is sufficiently flexible to be wrapped in at least one convolution, but preferably two or more convolutions, around the flashlight barrel. After being so wrapped, the shaft 16, and particularly the material of the core 17, retains that spiral shape to hold the flashlight securely. To illuminate a desired work area, the user attaches the magnetic bottom surface of the base 12 to an adjacent metal object and then bends the shaft 16 as necessary to aim the flashlight at the work area. Although the shaft 16 is shapeable by hand, it is sufficiently stiff to retain the orientation of the flashlight to illuminate the work area. When it is desired to remove the flashlight 26 and holder 10, the user pulls on the handle 14 to disengage the magnet 22 from the surface to which it is held. By providing the handle 14, the worker does not have to pull on the shaft 16 which over time could dislodge the shaft from the base 12.

FIG. 6 illustrates a second version of a flashlight holder 30 according to the present invention. In this version, the shaft 32 is attached directly to the base 34 wherein the proximate end of the shaft contacts the base. As shown in FIG. 7, a conventional strain relief 38, such as a spring for example, may extend between the base 34 and the flexible shaft 16 to restrict the shaft flexing sharply at that point after extensive use could produce fatigue and weakening in the shaft. As seen in both FIGS. 6 and 7, a handle 36 in the form of a finger ring is attached, such as by welding, to the upper surface of the base 34. This handle is to be grasped by the user's fingers to disengage the magnet 22 from the supporting object near the work area. This avoids the user having to pull on the shaft 32, which as noted previously could over time cause the shaft to dislodge from the base 34. It should be understood that other forms of handles can be secured to the base for grasping by the user to disengage the magnetic base from a workpiece. The second version of a flashlight holder 30 of does not have the polymer foam coating and the knob 20 at the shaft tip, although one or both of those elements could be included.

The foregoing description was primarily directed to one or more embodiments of the invention. Although some attention has been given to various alternatives within the scope of the invention, it is anticipated that one skilled in the art will likely realize additional alternatives that are now apparent from disclosure of embodiments of the invention. Accordingly, the scope of the invention should be determined from the following claims and not limited by the above disclosure.

1. A holder for a flashlight comprising:
a base comprising a permanent magnet; and
a shaft having a first end connected to the base and the shaft comprises an elongated, flexible metal core, wherein upon the shaft being bent into a given shape around flashlight, the core retains the given shape to hold onto the flashlight.

2. The holder as recited in claim 1 wherein the core is fabricated of a metal selected from the group consisting of lead, zinc, copper, aluminum, iron, steel, and alloys thereof.

3. The holder as recited in claim 1 wherein the shaft further comprises a resilient coating on the core.

4. The holder as recited in claim 1 wherein the shaft further comprises a coating on the core, wherein the coating is one of plastic and rubber.

5. The holder as recited in claim 1 wherein the shaft has a second end and further comprises a knob attached to the second end.

6. The holder as recited in claim 1 wherein a section of the shaft remote from the first end is covered by one of a polymer or a polymer foam.

7. The holder as recited in claim 1 further comprising a handle engaged by both the base and the shaft.

8. The holder as recited in claim 7 further comprising a plate attached to the handle.

9. The holder as recited in claim 1 further comprising a handle engaging the base; and a strain relief engaging the handle and the shaft.

10. The holder as recited in claim 1 further comprising a strain relief connecting the shaft to the base.

11. The holder as recited in claim 10 wherein the strain relief comprises an coil spring having one end engaging the base and another end engaging the shaft.

12. The holder as recited in claim 1 further comprising a handle separated from the shaft and engaging the base.

13. A holder for a flashlight comprising:
a base first and second opposing surfaces, with a permanent magnet facing the second opposing surface; and
a shaft having a first end connected to the first surface of the base and comprising an elongated, flexible metal core surrounded by a resilient coating, wherein upon the shaft being bent into a given shape around flashlight, the core the shaft retains the given shape to hold the flashlight.

14. The holder as recited in claim 13 wherein the core is fabricated of a metal selected from the group consisting of lead, zinc, copper, aluminum, iron, steel, and alloys thereof.

15. The holder as recited in claim 13 wherein the resilient coating is fabricated of a one of plastic and rubber.

16. The holder as recited in claim 13 wherein a section of the shaft remote from the first end is covered by one of a polymer or a polymer foam.

17. The holder as recited in claim 13 further comprising a handle engaged by both the base and the shaft.

18. The holder as recited in claim 13 further comprising a handle engaging the base; and a strain relief extending between the handle and the shaft.

19. The holder as recited in claim 13 further comprising a handle connecting the shaft to the base; and a plate attached to the handle.

20. The holder as recited in claim 13 further comprising a strain relief attaching the shaft to the base.

21. The holder as recited in claim 20 wherein the strain relief comprises an coil spring having one end engaging the base and another end engaging the shaft.

22. The holder as recited in claim 13 further comprising a handle separated from the shaft and engaging the base.
